(19) United States
(12) Patent Application Publication
(10) Pub. No.: US 2025/0339250 A1
(43) Pub. Date: Nov. 6, 2025

(54) Flossing Device

(71) Applicant: Kevin McCarty, Texarkana, TX (US)

(72) Inventor: Kevin McCarty, Texarkana, TX (US)

(21) Appl. No.: 18/652,198

(22) Filed: May 1, 2024

(51) Int. Cl. A61C 15/04

(52) U.S. Cl. CPC A61C 15/046

(57) ABSTRACT

A flosser having a body and a c-shaped head coupled to the first end of the body. The c-shaped head can include a pin. The flosser can also include a spool disposed inside a cavity at the second end of the body, wherein the spool is configured to be wound with floss. The flosser can also include a lock disposed inside the cavity between the spool and the first end of the body. The lock can be configured to move within the cavity between an open position and a closed position. The flosser can also include a floss path extending between the spool and the c-shaped head. The floss path can be configured to accommodate floss threaded through the floss path and secured to the pin. A position of the floss threaded through the floss path can be maintained when the lock is in the closed position.

### CROSS-REFERENCE TO RELATED APPLICATIONS

Not Applicable.

### BACKGROUND

### Technical Field

The present disclosure relates to oral care devices and, more particularly, to flossing devices.

### Description of Related Art

Dental floss can improve oral health when properly used. Flossing can effectively assist in eliminating plaque and food debris between teeth and along the gumline, polishes tooth surfaces, and may help control bad breath.

### BRIEF SUMMARY

This summary provides a discussion of aspects of certain embodiments of the invention. It is not intended to limit the claimed invention or any of the terms in the claims. The summary provides some aspects but there are aspects and embodiments of the invention that are not discussed here.

In one aspect, a flosser is provided. The flosser can include a body and a c-shaped head coupled to the first end of the body. The c-shaped head can include a pin. The flosser can also include a spool disposed inside a cavity at the second end of the body, wherein the spool is configured to be wound with floss. The flosser can also include a lock disposed inside the cavity between the spool and the first end of the body. The lock can be configured to move within the cavity between an open position and a closed position. The flosser can also include a floss path extending between the spool and the c-shaped head. The floss path can be configured to accommodate floss threaded through the floss path and secured to the pin. A position of the floss threaded through the floss path can be maintained when the lock is in the closed position.

In one embodiment, the flosser can also include a strand-clamping actuator movably engaged with the lock. The strand-clamping actuator is configured to be moved along a length of the body to cause the lock to move between the open position and the closed position. The strand-clamping actuator can include a collar and a rod. The rod can extend through an aperture in the cavity and engage with the lock, and the collar can be movably engaged with an exterior surface of the body such that moving the collar along the exterior surface moves the lock between the open position and the closed position.

In another embodiment, the body comprises a handle and a neck. The neck interconnects the handle and the c-shaped head, and the handle defines the cavity of the body. The pin can be a retractable pin, and the neck can include a pin actuator connected to the retractable pin and configured to move the retractable pin between an extended position and a contracted position. The pin actuator can include a spring, whereby the pin actuator is spring-tensioned such that a sufficient amount of force must be applied to the pin actuator to move the retractable pin from the contracted position to the extended position.

The neck can include a cover that defines a channel therein. The cover can have an aperture. The pin actuator and the spring can be disposed within the channel of the cover, and the pin actuator can have a nub extending through the aperture of the cover.

The neck can include a channel and a sleeve, with the channel extending between the c-shaped head and the handle, and the sleeve being disposed along a portion of the channel. The pin actuator can be disposed within the channel, and the pin actuator can include a nub. The spring can interconnect the nub and the sleeve such that the spring provides a resistance to moving the retractable pin between the extended position and the contracted position.

The pin actuator can include a clasp at a first end and an axial protrusion from the nub at a second end. The retractable pin can include a nub at a proximal end and a cutout at a distal end, and the clasp can engage the cutout. The spring can be interconnected between the axial protrusion of the nub and the sleeve. The floss can be secured around the cutout of the retractable pin.

In another embodiment, the flosser can also include a shell disposed in the cavity of the body. The lock can include a set of teeth, and the shell can include a set of recesses formed in the interior of the shell. The set of teeth can be configured to mesh with the set of recesses when the lock is in the closed position. The lock can be disposed in the interior of the shell and can be movable along a length of the shell.

The flosser can also include a lock pin and a spring. The lock can include a compartment housing the lock pin and the spring. A side wall of the compartment can have an aperture, and a first end of the lock pin can extend out of the aperture and a second end of the lock pin can be movably engaged with an opposing side wall via the spring. A side wall of the interior of the shell can include a protrusion configured to engage the lock pin when the lock is moved between the open position and the closed position. The cavity can have a plurality of recesses, and an outer surface of the shell can have a plurality of ribs configured to engage with the plurality of recesses.

In yet another embodiment, a first portion of the floss path extends through the cavity, a second portion of the floss path is formed in a side of the shell, a third portion of the floss path is formed in a side of the neck, and a fourth portion of the floss path is formed in a side of the c-shaped head.

The third portion and the fourth portion can be on the same side, and the second portion can be on an opposing side of the third portion and the fourth portion.

The handle can include one or more protrusions positioned at the first end of the handle. The one or more protrusions can be configured to engage the floss between the second portion and the third portion of the floss path. The neck can have a pin positioned on the side of the neck such that the pin secures the floss within the third portion of the floss path. The handle can have a first protrusion and a second protrusion, with the first protrusion and the second protrusion being arranged in a staggered position.

The c-shaped head can have a first prong and a second prong. The retractable pin can be disposed within the first prong, and the fourth portion of the floss path can be formed in the side of the second prong.

In another embodiment, a shell disposed in the cavity of the body. The lock can have a set of teeth, and the shell can have a set of recesses formed in an interior of the shell. The set of teeth can be configured to mesh with the set of recesses when the lock is in the closed position. The lock can be disposed in the interior of the shell and is movable along a length of the shell. The rod can extend through an aperture in the shell to engage with the lock.

The flosser can include a lock pin and a spring. The lock can include a compartment housing the lock pin and the spring. A side wall of the compartment can have an aperture, and a first end of the lock pin can extend out of the aperture. A second end of the lock pin can be movably engaged with an opposing side wall via the spring. A side wall of the interior of the shell can have a protrusion configured to engage the lock pin when the lock is moved between the open position and the closed position. The shell can have a first portion and a second portion, with the set of recesses formed in the first portion of the shell. The rod can extend through the aperture in the second portion of the shell.

### BRIEF DESCRIPTION OF THE DRAWINGS

The preceding aspects and many of the attendant advantages of the present technology will become more readily appreciated by reference to the following Detailed Description when taken in conjunction with the accompanying simplified drawings of example embodiments. The drawings briefly described below are presented for ease of explanation and do not limit the scope of the claimed subject matter.

FIG. 1 depicts a top view of an embodiment of a flosser device.

FIG. 2 depicts an exploded view of the flosser device in FIG. 1.

FIG. 3A depicts an embodiment of a flosser device lock in an open position.

FIG. 3B depicts an embodiment of a flosser device lock in a closed position.

FIG. 4A depicts an embodiment of a flosser device pin in an extended position.

FIG. 4B depicts an embodiment of a flosser device pin in a contracted position.

FIG. 5A depicts an embodiment of a flosser with a lock in an open position.

FIG. 5B depicts an embodiment of a flosser with a lock in an closed position.

FIG. 6 depicts a side view of the flosser device in FIG. 1.

FIG. 7 depicts another side view of the flosser device in FIG. 1.

### DETAILED DESCRIPTION

The present disclosure relates to flosser that allows a user to adjust the length of floss to create a variety of curved angles. This configuration provides an advantage of allowing the floss to wrap around the sides of a tooth (or teeth), providing optimum coverage of all edges of the teeth.

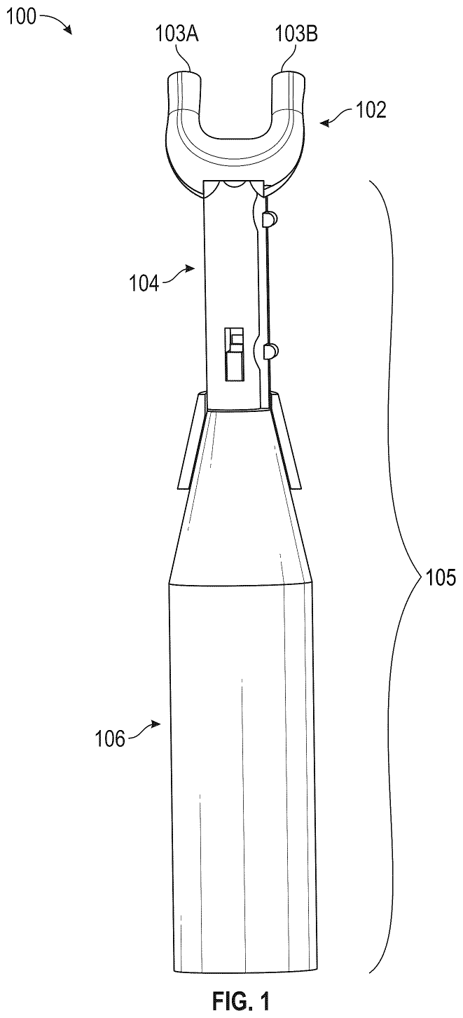

Turning to FIG. 1, an embodiment of a flosser (or flosser device) 100 is illustrated. Flosser 100 can include body 105 and head 102. In the illustrative embodiment, body 105 can comprise handle 106 and neck 104, with neck 104 interconnecting head 102 and handle 106. Handle 106 and neck 104 may be a unitary structure or separate components that form body 105. Head 102 can be a c-shaped head having a first prong 103A and a second prong 103B.

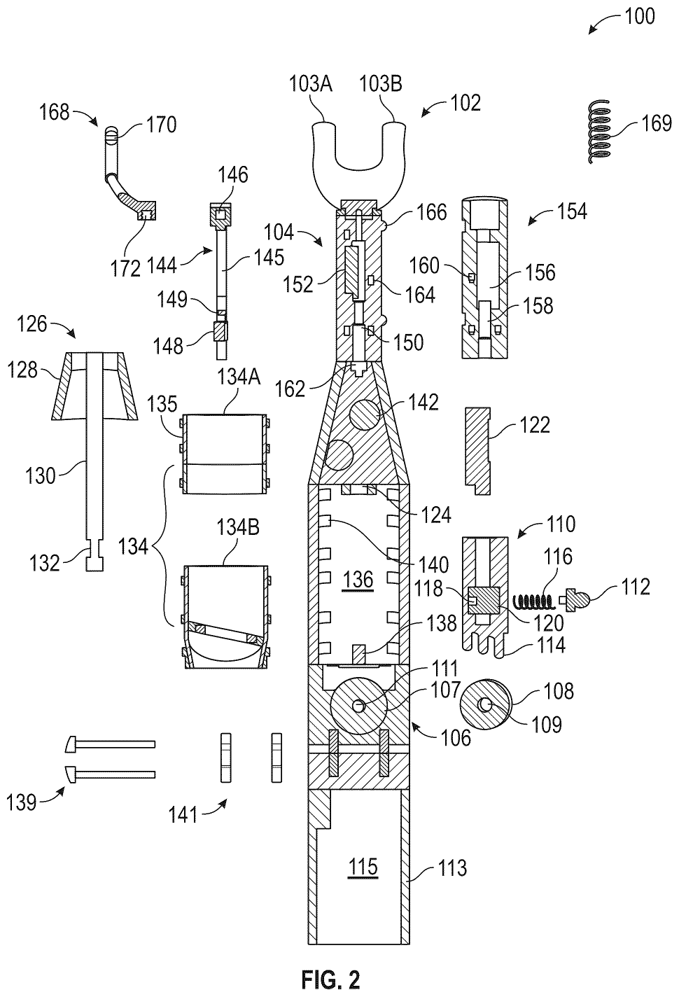

With reference to FIG. 2, an exploded view of flosser 100 is illustrated. Head 102 can include pin 168 disposed in the first prong 103A of head 102. Pin 168 may include a cutout 170 at a distal end and a nub 172 at a proximal end. Pin 168 can be configured to be a retractable pin 168, configured to be positioned in an extended position and a contracted position, as explained below.

Neck 104 can comprise a channel 150 formed in neck 104. In the illustrative embodiment, channel 150 can extend the entire length of neck 104. Sleeve 152 is positioned to cover at least a portion of channel 150. Pin actuator 144 can be placed in channel 150 and connected to retractable pin 160. Pin actuator 144 includes clasp 146, rod 145, and nub 148. Clasp 146 is positioned at a first end of rod 145 and nub 148 is positioned at a second end of rod 145. Nub 148 can include an axial protrusion 149. Clasp 146 connects to nub 172 of retractable pin 168. Spring 169 is placed between nub 148 and sleeve 152. In the illustrative embodiment, spring 169 is wrapped around protrusion 149 and a corresponding protrusion 153 (FIG. 4B), securing spring 169 in place. Spring 169 causes pin actuator 144 to be spring-tensioned such that pin actuator 144 rests in a first position where the second end of rod 145 abuts clasp 162. When pin actuator 144 is in the first position, retractable pin 168 is in a contracted position. In the illustrative embodiment, a user must apply a sufficient amount of force to compress spring 169 to move pin actuator 144 to a second position. When pin actuator 144 is in the second position, retractable pin 168 is in an extended position.

Neck 104 can also include cover 154 on the surface of neck 104. Cover 154 can include channel 156 formed therein and aperture 158. Channel 156 is configured to accommodate a portion of rod 145 that is exposed from channel 150. Nub 148 is configured to protrude through aperture 158. Aperture 158 is sized and configured to allow nub 148 to slide along the length of neck 104 to allow spring 169 to be compressed and released. Cover 154 can also include a plurality of protrusions 160 that are configured to fit into corresponding recesses 164 formed in neck 104. Additionally, or alternatively, neck 104 may comprise a plurality of protrusions that are configured to fit into corresponding recesses formed in cover 154. In the illustrative embodiment, cover 154 spans the length of neck 104.

With continued reference to FIG. 2, handle 106 includes cavity 136 formed in a portion of handle 106. Shell 134 is configured to fit inside cavity 136. In the illustrative embodiment, shell 134 comprises a first portion 134A and a second portion 134B. The first portion 134A is positioned at a distal end of cavity 136 and the second portion 134B is positioned at a proximal end of cavity 136. Shell 134 can include a plurality of ribs 135 protruding from the sides of shell 134 that are configured to fit into corresponding recesses 140 formed in cavity 136, securing shell 134 within cavity 136. Cavity 136 can also include nub 138 protruding from a sidewall. Nub 138 is configured to fit within a corresponding recess (not illustrated) formed in the surface of shell 134.

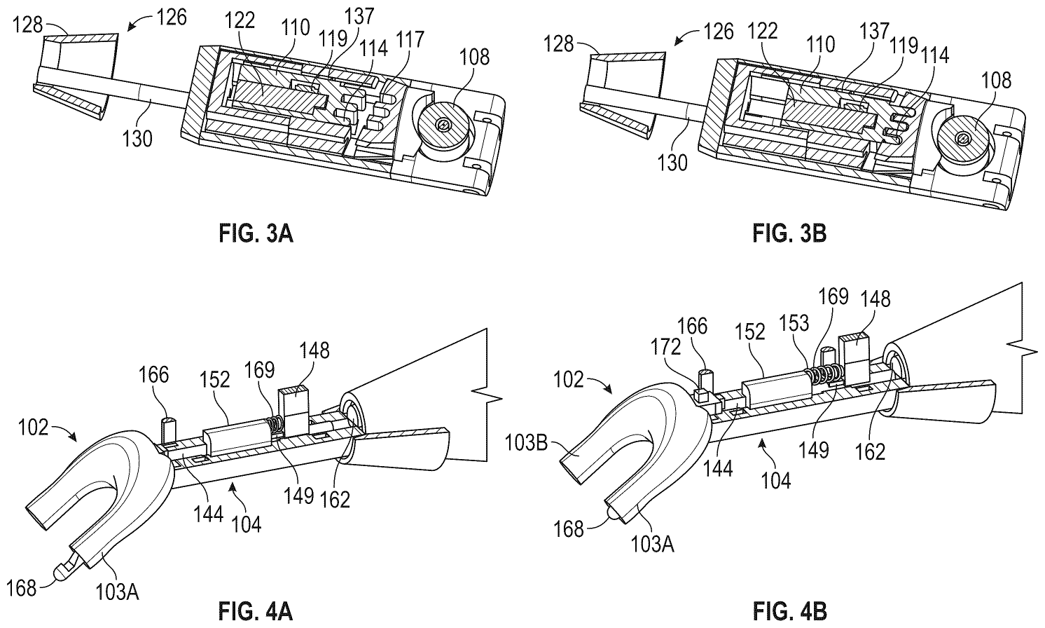

Lock 110, which is configured to be disposed within shell 134 (e.g., FIGS. 3A-3B), can comprise compartment 120, which can have nub 118 protruding from a sidewall therein. Compartment 120 can include an aperture 119 (e.g., FIGS. 3A-3B) in the sidewall opposing nub 118. A first end of spring 116 is coupled around nub 118, and a second end of spring 116 is coupled around a nub of lock pin 112. A portion of lock pin 112 is configured to protrude through aperture 119. Lock 110 further includes a set of teeth 114 at a proximal end. In the illustrative embodiment, lock 110 includes a three-tooth configuration. However, lock 110 can be equipped with more or fewer teeth. Lock 110 can also include cover 122 that is configured to encase compartment 120. In at least one alternative embodiment, flosser 100 does not include shell 134, and lock 110 can be configured to be disposed within cavity 136. The strength of lock 110 can be established through various configurations. For example, the coefficient of friction between the components of lock 110 sliding within cavity 136 (or shell 134) may set the locking force of lock 110. In addition, or alternatively, the components of lock 110 sliding within cavity 136 (or shell 134) can be modified (e.g., increasing surface roughness) to increase the locking strength. Additionally, or alternatively, materials with high coefficients of friction (e.g., rubber) can be applied to the components of lock 110 sliding within cavity 136 (or shell 134).

Handle 106 can also include compartment 107 having a pin 111 disposed therein. Spool 108 is configured to be placed in compartment 107, with pin 111 fitting through aperture 109 of spool 108, allowing spool 108 to rotate within compartment 107 around pin 111. Spool 108 is configured to be wound with dental floss. At an opposing end, handle 106 can include a set of protrusions 142 positioned between cavity 136 and clasp 162. As explained below, protrusions 142 guide a strand of floss that is threaded through flosser 100. Alternatively, handle 106 can be configured such that a channel (not illustrated) is defined therein, allowing a strand of floss to be threaded through flosser 100.

In the illustrative embodiment, handle 106 includes cover 113 that is rotatably attached to handle 106 via hinges 141, which are secured via pins 139. Cover 113 defines cavity 115 that is sized and configured encapsulate the contents of handle 106. Cover 113 is configured to engage with clasp 162 to secure cover 113 in place. In one embodiment, cover 113 is secured to handle 106 by closing cover 113 and sliding cover 113 forward to engage with clasp 162. To open cover 113, cover 113 is slid backward (i.e., away from clasp 162).

Flosser 100 can also include strand-clamping actuator 126 that is configured to engage with lock 110. Strand-clamping actuator 126 includes rod 130 and collar 128 secured to a distal end of rod 130. Strand-clamping actuator 126 can also include cutout 132 formed in a proximal end of rod 130. Rod 130 is configured to fit through aperture 124 formed in the distal end of cavity 136. Cutout 132 engages lock 110, such that moving spring-clamping actuator 126 along the length of handle 106 moves lock 110 within cavity 136 or shell 134. Collar 128 enables a user to move strand-clamping actuator 126 (and lock 110).

Turning to FIGS. 3A and 3B, an embodiment of lock 110 in an open position (FIG. 3A) and a closed position (FIG. 3B) are illustrated. When lock 110 is in the open position, it is positioned at the distal end of cavity 136 (or shell 134). On the other hand, when lock 110 is in the closed position, it is positioned at the proximal end of cavity 136 (or shell 134). In the illustrative embodiment, lock pin 112 (see FIG. 1) engages with rib 137 to maintain lock 110 in the open or closed position. As lock 110 is moved within cavity 136 (or shell 134) by strand-clamping actuator 126, lock pin 112 is compressed by rib 137, allowing lock 110 to move between the open position and the closed position.

With reference to FIGS. 4A and 4B, an embodiment of retractable pin 168 in an extended position (FIG. 4A) and a contracted position (FIG. 4B) is illustrated. In FIG. 4A, retractable pin 168 is in the extended position by applying a force on nub 148 to move pin actuator 144 to the second position, where spring 169 is in a compressed state. The extended position allows a user to secure a strand of floss around cutout 170 (FIG. 1) of retractable pin 168. Nub 149 provides a limit on the distance pin actuator 144 can move toward sleeve 152. Additionally, or alternatively, nub 149 and the corresponding nub on sleeve 152 (not illustrated) can limit the distance pin actuator 144 can move toward sleeve 152. In FIG. 4B, retractable pin 168 is in the contracted position, where spring 169 is in a non-compressed (or steady state) position. The contracted position allows the user to maintain the strand of floss being secured to retractable pin 168 during use, as the first prong 103A secures the strand of floss around cutout 170.

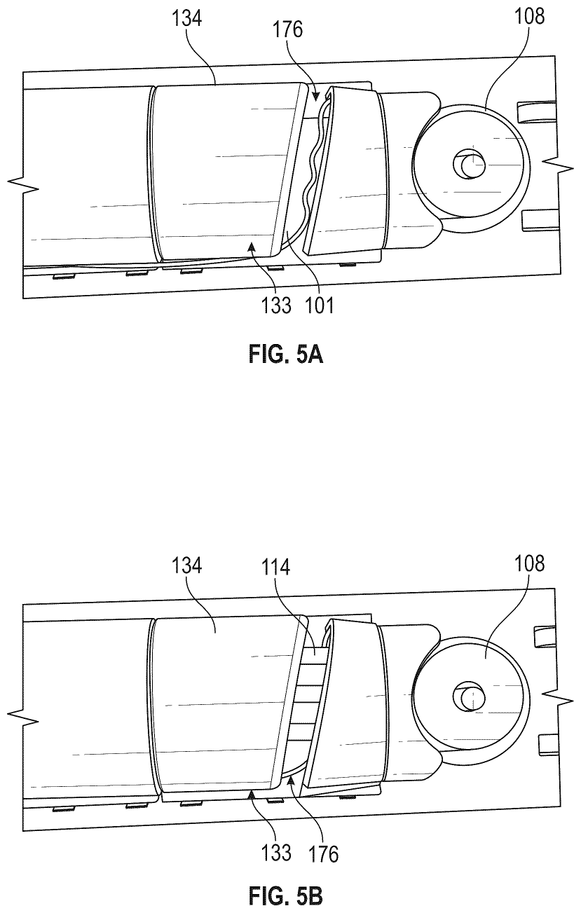

Turning to FIGS. 5A and 5B, an embodiment of flosser 100 is illustrated. In FIG. 5A, lock 110 (not illustrated) is in the open position. A strand of floss 101 is threaded from spool 108 through a channel 176 in shell 134 and through channel 133 formed along the side surface of shell 134. In FIG. 5B, lock 110 (not illustrated) is in the closed position. Teeth 114 of lock 110 are engaged with recesses 117 (FIG. 3A) and secure the position of the strand of floss 101. When lock 110 secures the position of the strand of floss 101 via teeth 114 and recesses 117, the strand of floss cannot be threaded along the length of the flosser 100, ensuring that the strand of floss 101 does not move during use.

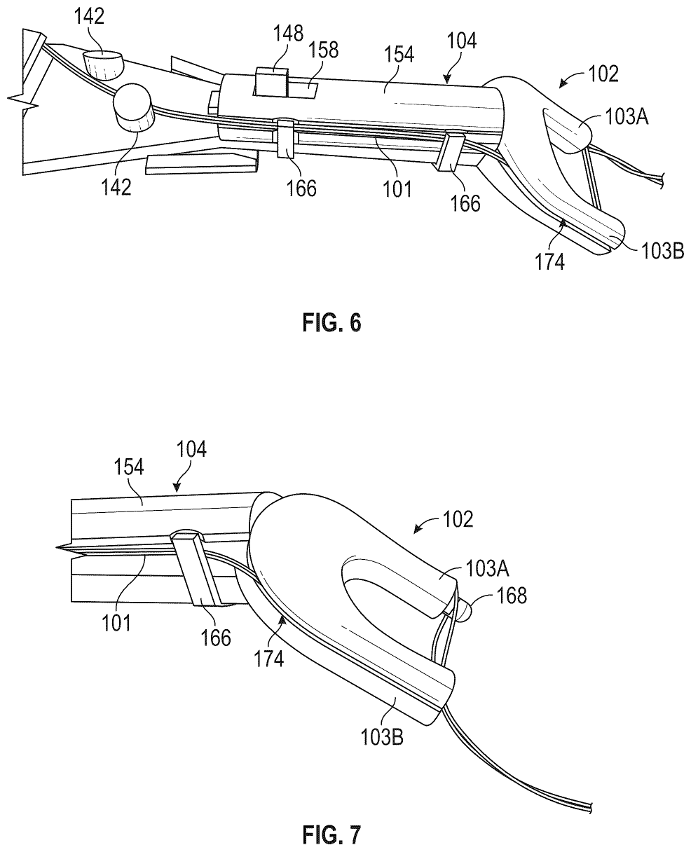

Referring to FIG. 6, a side view of an embodiment of flosser 100 with retractable pin 168 in a contracted position is illustrated. The strand of floss 101 is threaded through channel 133 (FIGS. 5A and 5B) and between protrusions 142. Alternatively, as mentioned above, floss 101 can be threaded through a channel (not illustrated) molded within handle 106. The strand of floss 101 is threaded through channel 174 formed in the side of neck 104 and the second prong 103B of head 102. In the illustrative embodiment, neck 104 can include pins 166 formed on the side of neck 104, securing the stand of floss 101 within channel 174. Alternatively, neck 104 can include a shell (not illustrated) formed on the side of neck 104, securing the stand of floss 101 within channel 174. The strand of floss 101 is also threaded around the second prong 103B and secured to retractable pin 168 (not illustrated) inside the first prong 103A.

With reference to FIG. 7, a side view of an embodiment of flosser 100 with retractable pin 168 in an extended position is illustrated. The strand of floss 101 can be secured to retractable pin 168 by wrapping the floss 101 around cutout 170 (FIG. 1) of retractable pin 168.

With reference to FIGS. 5A-7, a floss path for accommodated a strand of floss 101 can be defined by the various components of flosser 100. In one embodiment, the floss path can comprise four portions. The first portion of the floss path can be defined by channel 176 through shell 134. The second portion of the floss path can be defined by channel 133 formed in the side of shell 134. The third portion of the floss path can be defined by channel 174 formed in the side of neck 104. The fourth portion of the floss path can be defined by channel 174 formed in the side of head 102. In another embodiment, the floss path can comprise five portions. The first portion of the floss path can be defined by channel 176 through shell 134. The second portion of the floss path can be defined by channel 133 formed in the side of shell 134. The third portion of the floss path can be defined by protrusions 142 in handle 106. The fourth portion of the floss path can be defined by channel 174 formed in the side of neck 104. The fifth portion of the floss path can be defined by channel 174 formed in the side of head 102. The number of portions of the floss path can include more or fewer portions than those described herein.

### Example Operation

In one embodiment, flosser 100 can be operated according to the following method. The method can begin by placing a floss-wrapped spool 108 in compartment 107 of body 106. Next, a strand of floss 101 is pulled from spool 108 and threaded through channel 176 in shell 134 while lock 110 is in the open position. The strand of floss 101 is then pulled through channel 133 and between protrusions 142. The method continues by threading the strand of floss 101 inside of pins 166 and through channel 174 in the side of neck 104. The strand of floss can then be pulled through channel 174 formed in the side of the second prong 134B of head 102 and around retractable pin 168 while retractable pin 168 is in the extended position. After selecting the length of thread pulled from spool 108, the method can continue with releasing pin actuator 144, causing retractable pin 168 to move to the contracted position.

The ability to select the length of floss 101 provides an advantage of creating a variety of angles with which to floss. For example, by selecting a length longer than the minimum length needed to secure the floss 101 to the retractable pin 168 (e.g., not taut), the extra length allows the floss to wrap around the teeth. This wrapping feature allows the floss to wrap around the sides of the tooth, providing optimum (or maximum) coverage around the edges of the teeth. In other words, the adjustable floss length configuration enables flosser 100 to provide the same functionality as traditional flossing (i.e., manual hand flossing) but provides superior control and access to hard-to-reach areas (e.g., back teeth).

As mentioned above, lock 110 can be configured to have a threshold locking strength. For example, lock 110 could be configured to release (i.e., slide to the open position) when the user applies a pulling force during use. This advantageously protects the oral health of the user, as applying too great of a pulling force may damage the gums or the teeth. However, the locking strength may be increased (or decreased) for users that might desire a larger pulling force.

After completing the use, flosser 100 can be configured for another use by moving pin actuator 144 toward head 102 to cause retractable pin 168 to move to the extended position where the strand of floss can be removed. Once the floss 101 is removed, pin actuator 144 can be released, moving retractable pin 168 to the contracted position. Cover 113 can then be opened, allowing the user to pull the floss through the floss path until the desired length of floss is obtained. Then cover 113 is closed and pin actuator 144 is moved forward to place retractable pin 168 in the extended position. Once the floss 101 is secured to retractable pin 168, pin actuator 144 can be released to move retractable pin 168 to the contracted position.

Moreover, for the purposes of the present disclosure, the term “a” or “an” entity refers to one or more of that entity. As such, the terms “a” or “an,” “one or more,” and “at least one” can be used interchangeably herein.

All numeric values herein are assumed to be modified by the term “about,” whether or not explicitly indicated. For the purposes of the present invention, ranges may be expressed as from “about” one particular value to “about” another particular value. It will be understood that the endpoints of each of the ranges are significant both in relation to the other endpoint and independently of the other endpoint. When a value is expressed as an approximation by use of the antecedent “about,” it will be understood that the particular value forms another embodiment.

Additionally, the section headings herein are provided for consistency with the suggestions under 37 C.F.R. § 1.77 or to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that a particular technology is prior art to any embodiment(s) in this disclosure. Neither is the “Summary” a characterization of the embodiment(s) outlined in issued claims.

Furthermore, any reference in this disclosure to “invention” in the singular should not be used to argue that there is only a single point of novelty in this disclosure. Multiple embodiments may be set forth according to the limitations of the multiple claims issuing from this disclosure. Such claims accordingly define the embodiment(s) and their equivalents that are protected thereby. In all instances, the scope of such claims shall be considered on their own merits in light of this disclosure but should not be constrained by the headings set forth herein.

Moreover, the Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the preceding Detailed Description, it can be seen that various features may be grouped in a single embodiment to streamline the disclosure. This method of disclosure is not to be interpreted as reflecting an intention that the claimed embodiments require more features than are expressly recited in each claim. Instead, as the claims reflect, the inventive subject matter lies in less than all features of a single disclosed embodiment. Thus, the following claims are incorporated into the Detailed Description, with each claim standing on its own as a separate embodiment.

What is claimed is:

1. A flosser comprising:
a body having a first end and a second end, wherein the body defines a cavity therein;
a c-shaped head coupled to the first end of the body, wherein the c-shaped head comprises a pin;
a spool disposed inside the cavity at the second end of the body, wherein the spool is configured to be wound with floss;
a lock disposed inside the cavity between the spool and the first end of the body, wherein the lock is configured to move within the cavity between an open position and a closed position; and
a floss path extending between the spool and the c-shaped head, wherein the floss path is configured to accommodate floss threaded through the floss path and secured to the pin, and wherein a position of the floss threaded through the floss path is maintained when the lock is in the closed position.

2. The flosser of claim 1, further comprising a strand-clamping actuator movably engaged with the lock, wherein moving the strand-clamping actuator along a length of the body moves the lock between the open position and the closed position.

3. The flosser of claim 2, wherein the strand-clamping actuator comprises a collar and a rod, further wherein the rod extends through an aperture in the cavity and engages with the lock, and further wherein the collar is movably engaged with an exterior surface of the body such that moving the collar along the exterior surface moves the lock between the open position and the closed position.

4. The flosser of claim 1, wherein the body comprises a handle and a neck, the neck interconnecting the handle and the c-shaped head, wherein the handle defines the cavity of the body.

5. The flosser of claim 4, wherein the pin is a retractable pin, further wherein the neck comprises a pin actuator connected to the retractable pin and configured to move the retractable pin between an extended position and a contracted position.

6. The flosser of claim 5, wherein the pin actuator comprises a spring, whereby the pin actuator is spring-tensioned such that a sufficient amount of force must be applied to the pin actuator to move the retractable pin from the contracted position to the extended position.

7. The flosser of claim 1, further comprising a shell disposed in the cavity of the body, wherein:
the lock comprises a set of teeth, the shell comprises a set of recesses formed in an interior of the shell, the set of teeth configured to mesh with the set of recesses when the lock is in the closed position; and
the lock is disposed in the interior of the shell and is movable along a length of the shell.

8. The flosser of claim 7, further comprising a lock pin and a spring, wherein:
the lock comprises a compartment housing the lock pin and the spring, further wherein a side wall of the compartment comprises an aperture, further wherein a first end of the lock pin extends out of the aperture and a second end of the lock pin is movably engaged with an opposing side wall via the spring; and
a side wall of the interior of the shell comprises a protrusion configured to engage the lock pin when the lock is moved between the open position and the closed position.

9. The flosser of claim 7, wherein the cavity comprises a plurality of recesses, further wherein an outer surface of the shell comprises a plurality of ribs configured to engage with the plurality of recesses.

10. The flosser of claim 5, wherein the neck comprises a channel and a sleeve, the channel extending between the c-shaped head and the handle, the sleeve being disposed along a portion of the channel, the pin actuator being disposed within the channel, further wherein the pin actuator comprises a nub, the spring interconnecting the nub and the sleeve such that the spring provides a resistance to moving the retractable pin between the extended position and the contracted position.

11. The flosser of claim 10, wherein the pin actuator comprises a clasp at a first end and an axial protrusion from the nub at a second end, further wherein the retractable pin comprises a nub at a proximal end and a cutout at a distal end, further wherein the clasp engages to the cutout, further wherein the spring is interconnected between the axial protrusion of the nub and the sleeve, and further wherein the floss is secured around the cutout of the retractable pin.

12. The flosser of claim 7, wherein the body comprises a handle and a neck, the neck interconnecting the handle and the c-shaped head, further wherein the handle defines the cavity of the body, further wherein a first portion of the floss path extends through the cavity, further wherein a second portion of the floss path is formed in a side of the shell, further wherein a third portion of the floss path is formed in a side of the neck, and further wherein a fourth portion of the floss path is formed in a side of the c-shaped head.

13. The flosser of claim 12, wherein the third portion and the fourth portion are on the same side, and wherein the second portion is on an opposing side of the third portion and the fourth portion.

14. The flosser of claim 12, wherein the handle comprises one or more protrusions positioned at the first end of the handle, the one or more protrusions configured to engage the floss between the second portion and the third portion of the floss path.

15. The flosser of claim 14, wherein the neck comprises a pin positioned on the side of the neck such that the pin secures the floss within the third portion of the floss path.

16. The flosser of claim 14, wherein the handle comprises a first protrusion and a second protrusion, the first protrusion and the second protrusion being arranged in a staggered position.

17. The flosser of claim 13, wherein the c-shaped head comprises a first prong and a second prong, the retractable pin being disposed within the first prong, further wherein the fourth portion of the floss path is formed in the side of the second prong.

18. The flosser of claim 3, further comprising a shell disposed in the cavity of the body, wherein:
the lock comprises a set of teeth, the shell comprises a set of recesses formed in an interior of the shell, the set of teeth configured to mesh with the set of recesses when the lock is in the closed position;
the lock is disposed in the interior of the shell and is movable along a length of the shell; and
wherein the rod extends through an aperture in the shell.

19. The flosser of claim 18, further comprising a lock pin and a spring, wherein:
the lock comprises a compartment housing the lock pin and the spring, further wherein a side wall of the compartment comprises an aperture, further wherein a first end of the lock pin extends out of the aperture and a second end of the lock pin is movably engaged with an opposing side wall via the spring; and
a side wall of the interior of the shell comprises a protrusion configured to engage the lock pin when the lock is moved between the open position and the closed position;
the shell comprises a first portion and a second portion, the set of recesses formed in the first portion of the shell, the rod extends through the aperture in the second portion of the shell.

20. The flosser of claim 6, wherein the neck comprises a cover, wherein the cover defines a channel therein, further wherein the cover comprises an aperture, further wherein the pin actuator and the spring are disposed within the channel of the cover, and further wherein the pin actuator comprises a nub extending through the aperture of the cover.
